(19) United States
(12) Patent Application Publication
(10) Pub. No.: US 2010/0151920 A1
(43) Pub. Date: Jun. 17, 2010

(54) METHOD OF OPERATING BASE STATION WITH LOW POWER CONSUMPTION

(75) Inventors: Pyeong-jung SONG, Daejeon-si (KR); Hyun-seo PARK, Daejeon-si (KR); Yeon-seung SHIN, Daejeon-si (KR); Yeong-jin KIM, Daejeon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon-si (KR)

(21) Appl. No.: 12/582,322

(22) Filed: Oct. 20, 2009

(30) Foreign Application Priority Data
Dec. 16, 2008 (KR) 10-2008- 0128123

(51) Int. Cl. H04M 1/00

(52) U.S. Cl. 455/574

(57) ABSTRACT

Provided is a method of reducing power consumption of a base station. A method of operating a base station with low power consumption in a mobile communication system includes: reporting status information about a level of traffic being served by a base station in an active mode to an apparatus for managing power consumption of the base station; and switching from the active mode to an inactive mode in response to a mode change command from the apparatus.

### CROSS-REFERENCE TO RELATED APPLICATION

This application claims the benefit under 35 U.S.C. §119(a) of Korean Patent Application No. 10-2008-0128123, filed on Dec. 16, 2008, the disclosure of which is incorporated by reference in its entirety for all purposes.

### BACKGROUND

1. Field

The following description relates to a base station, and more particularly, to a technology for reducing power consumption of a base station.

2. Description of the Related Art

Generally, base stations consume power 24 hours a day, emitting heat and carbon dioxide. Therefore, high power consumption of base stations adversely affects the environment.

### SUMMARY

The following description relates to a method of reducing power consumption of a base station.

According to an exemplary aspect, there is provided a method of operating a base station with low power consumption in a mobile communication system. The method includes: reporting status information about a level of traffic being served by a base station in an active mode to an apparatus for managing power consumption of the base station; and switching from the active mode to an inactive mode in response to a mode change command from the apparatus.

The level of traffic is the number of call attempts made by user equipments (UEs) per unit time.

The inactive mode is a discontinuous reception (DRX) mode.

The base station is one of a home cell base station and a relay node.

According to another exemplary aspect, there is provided a method of controlling power consumption of a base station using an external apparatus. The method includes: receiving information about a level of traffic being served by a base station; and controlling a power mode of the base station based on the received information.

The controlling of the power mode includes: comparing the level of traffic with a predetermined threshold; and controlling the base station to operate in an active mode when the level of traffic is equal to or greater than the predetermined threshold and controlling the base station to operate in an inactive mode when the level of traffic is less than the predetermined threshold.

The controlling of the power mode includes: comparing the level of traffic with first and second thresholds; and controlling the base station to operate in the active mode when the level of traffic is equal to or greater than the first threshold, controlling the base station to operate in the inactive mode when the level of traffic is less than the second threshold, and controlling the base station to hand a UE being served by the base station over to a nearby base station and then operate in the inactive mode when the level of traffic is equal to or greater than the second threshold and less than the first threshold.

According to another exemplary aspect, there is provided a method of controlling power consumption of a base station using an external apparatus. The method includes: receiving information about a level of traffic being served by a base station from the base station in an active mode; comparing the level of traffic with a predetermined threshold; controlling the base station to operate in an inactive mode when the level of traffic is less than the predetermined threshold; monitoring the base station to detect call attempts to the base station in the inactive mode; and controlling the base station to operate in the active mode when the number of call attempts to the base station is equal to or greater than the predetermined threshold.

According to another exemplary aspect, there is provided a method of controlling power consumption of a base station using an external apparatus. The method includes: receiving information about a level of traffic being served by a base station from the base station in an active mode; comparing the level of traffic with first and second thresholds; controlling the base station to operate in an inactive mode when the level of traffic is less than the second threshold and controlling the base station to hand a UE being served by the base station over to a nearby base station and then operate in the inactive mode when the level of traffic is equal to or greater than the second threshold and less than the first threshold; monitoring the base station to detect call attempts to the base station in the inactive mode; and controlling the base station to operate in the active mode when the number of call attempts to the base station is equal to or greater than the first threshold.

Other objects, features and advantages will be apparent from the following description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain aspects of the invention.

FIG. 1 is a block diagram of a mobile communication access network;

FIG. 2 illustrates a threshold of the number of call attempts made by user equipments (UEs) to a base station;

FIG. 3 illustrates a discontinuous reception (DRX) cycle of a base station;

FIG. 4 is a flowchart illustrating a process in which a network management server (NMS) determines the power mode of a base station;

FIG. 5 is a flowchart illustrating a process in which a base station changes its power mode according to the measured level of traffic being served by the base station, under the control of an NMS;

FIG. 6 illustrates a process in which a base station switches from a DRX mode to an active mode; and

FIG. 7 is a flowchart illustrating a process in which a base station changes its power mode according to the measured level of traffic being served by the base station, under the control of an NMS.

### DETAILED DESCRIPTION

The above and other features and advantages of the present invention will become more apparent by describing exemplary embodiments thereof with reference to the attached drawings. Exemplary embodiments of the present invention will now be described in detail so that they can be readily understood and applied by those skilled in the art.

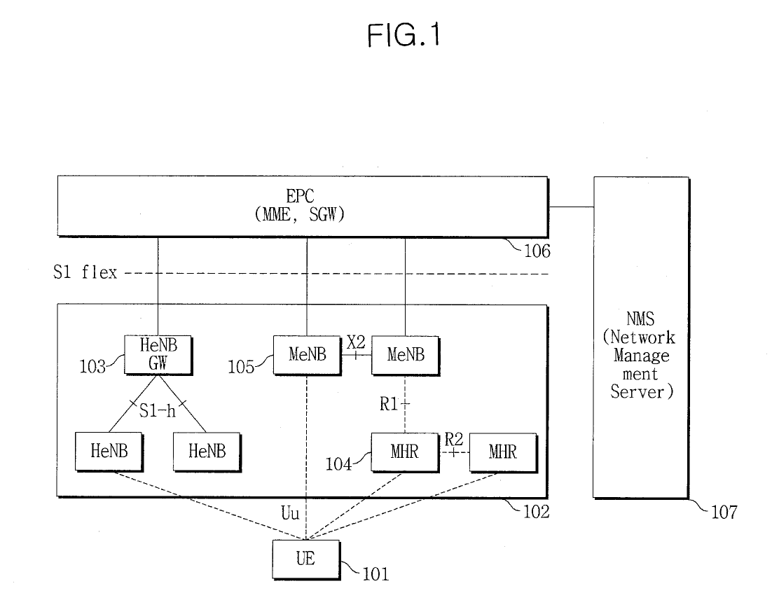

FIG. 1 is a block diagram of a mobile communication access network. Referring to FIG. 1, the mobile communication access network consists of one or more home cell base stations (Home eNodeBs (HeNBs)) 102, a home gateway (HeNB GW) 103 which concentrates or distributes traffic of the HeNBs 102, one or more multi-hop relay (MHR) nodes 104, and one or more macro base stations (Macro eNodeBs (MeNBs)) 105 which serve as mother stations of the MHR nodes 104.

A network management server (NMS) 107 controls and manages the operation of the mobile communication access network using a packet core network 106. The NMS 107 operates and manages each of the HeNBs 102, the HeNB GW 103, the MHR nodes 104, and the MeNBs 105. In addition, the NMS 107 determines a power mode of a base station such as the HeNB 102 or the MHR node 104. According to an embodiment, a base station has two power modes. One is an active mode, and the other is an inactive mode. In the active mode, the base station is powered on. In the inactive mode, the base station is in a sleeping state, that is, is powered off. According to an embodiment, the inactive mode may be a discontinuous reception (DRX) mode.

A user equipment (UE) 101 can access the HeNBs 102, the MHR nodes 104, and the MeNBs 105 using a single model chip. When necessary, the UE 101 may include a modem chip needed to access a universal mobile telecommunication system (UMTS), a worldwide interoperability for microwave access (WiMAX), or the like.

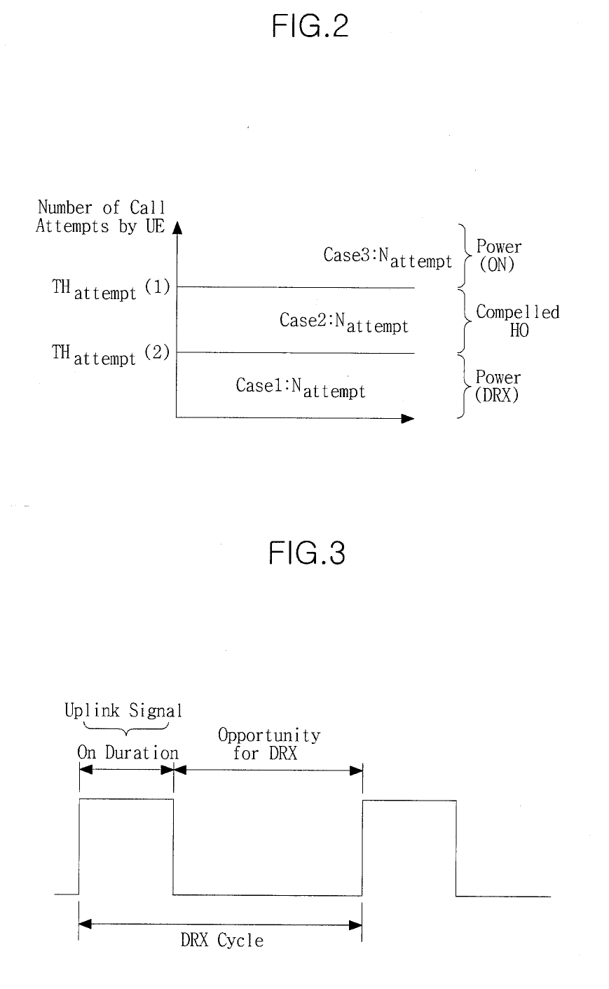

FIG. 2 illustrates a threshold of the number of call attempts made by UEs to a base station.

Referring to FIG. 2, a base station compares a preset threshold with a measured level of traffic and determines its power mode. The threshold and the measured level may be defined as follows.

\textcircled{1} A first threshold THₐₜₜₑₘₚₜ(1) is an upper threshold of the number of call attempts made by UEs to a base station (MHR or HeNB) in a unit of time.

\textcircled{2} A second threshold THₐₜₜₑₘₚₜ(2) is a lower threshold of the number of call attempts made by UEs to a base station (MHR or HeNB) in a unit of time.

\textcircled{3} A measured level Nₐₜₜₑₘₚₜ is the counted number of call attempts made by UEs to a base station (MHR or HeNB) in a unit of time.

A base station operates in any one of the DRX mode and the active mode. When the following condition is satisfied, the base station operates in the DRX mode.

Condition for DRX mode: Nₐₜₜₑₘₚₜ<THₐₜₜₑₘₚₜ (2).

FIG. 3 illustrates a DRX cycle of a base station. Referring to FIG. 3, when the condition for the DRX mode is satisfied, a base station enters a DRX cycle. The DRX cycle is divided into an active period (On Duration) and a sleeping period (Opportunity for DRX) that are repeated. Specified signals are received or transmitted only in the active period.

The base station monitors uplink signals in the active period to detect call attempts made by UEs to the base station. When detecting call attempts, the base station changes its power mode from the DRX mode to the active mode.

Transmission timing information of an uplink signal is delivered to UEs using a system information block (SIB). The system information block (SIB) includes the cycle of a system to information block (a master information block (MIB), SIBx) transmitted from a small base station. The cycle of the SIB can be adjusted using the cycle of the system information block (MIB, SIBx) transmitted from the small base station.

When an emergency call from a UE or a paging call of a network is detected, the base station quickly switches from the DRX mode to the active mode. To this end, the base station is continuously transmits a corresponding system information block (MIB, SIB1, SIB2, . . . , SIBn) and a reference signal to a UE.

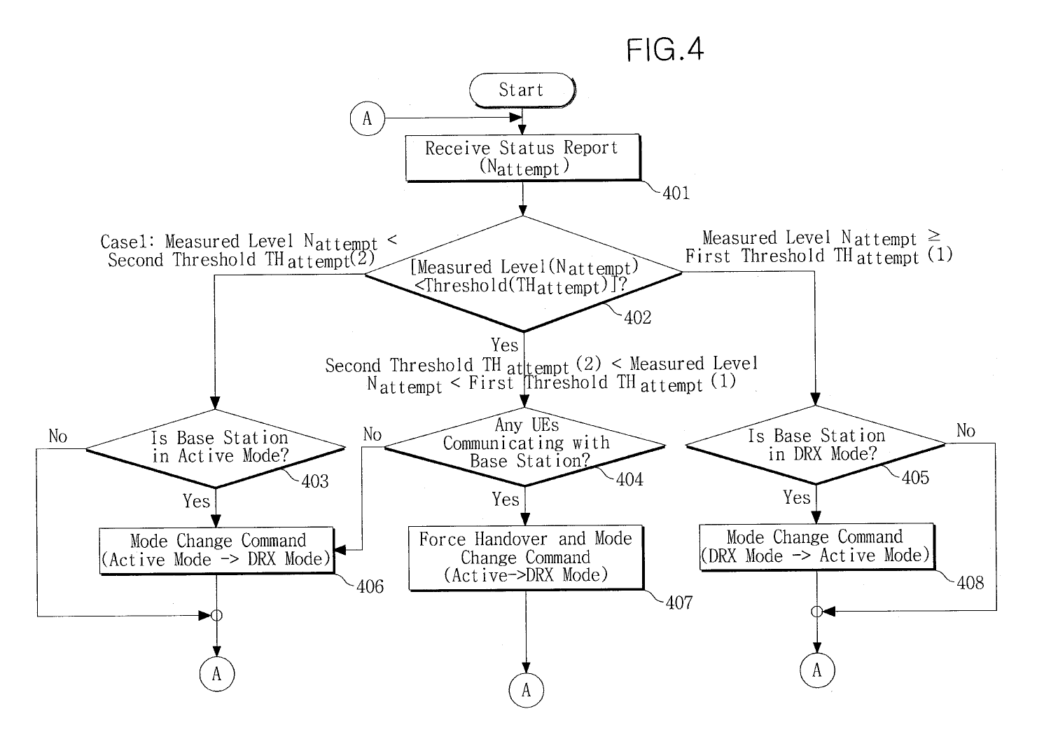

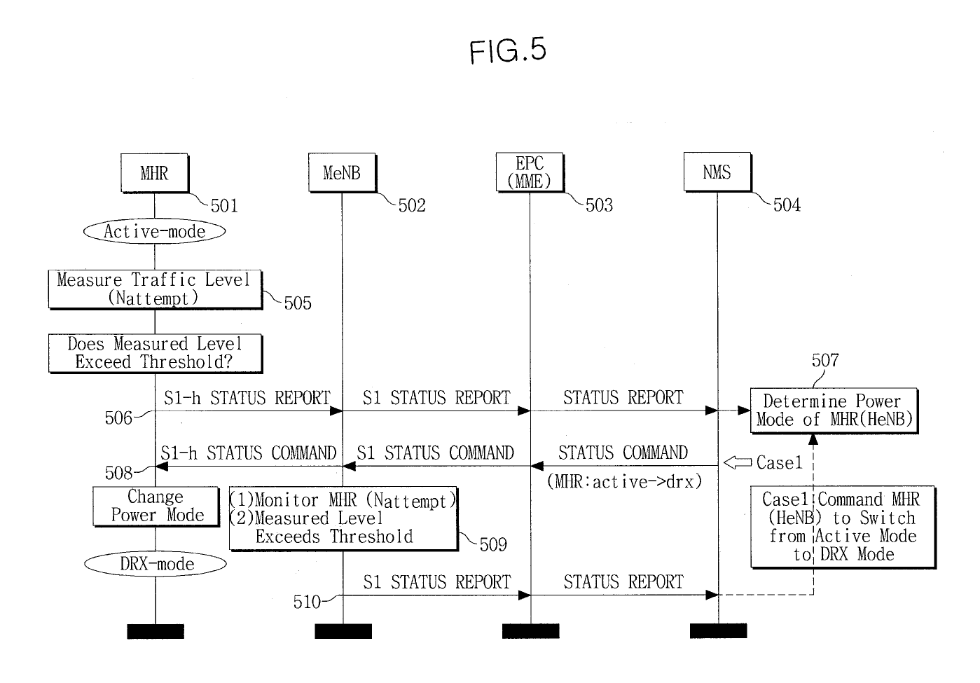

FIG. 4 is a flowchart illustrating a process in which the NMS 107 of FIG. 1 determines the power mode of a base station.

Referring to FIG. 4, the NMS 107 receives a status report from a base station (operation 401). The status report contains status information of traffic measured by the base station. The status information of traffic denotes information about a level of traffic served by the base station. The status information of traffic may be the measured level Nₐₜₜₑₘₚₜ mentioned earlier. The NMS 107 compares the measured level Nₐₜₜₑₘₚₜ with a threshold THₐₜₜₑₘₚₜ (operation 402).

When the measured level Nₐₜₜₑₘₚₜ is equal to or less than the second threshold THₐₜₜₑₘₚₜ (2), the NMS 107 checks whether a power mode of the base station is in the active mode (operation 403). When the power mode of the base station is in the active mode, the NMS 107 commands the base station to switch from the active mode to the DRX mode (operation 406).

When the measured level Nₐₜₜₑₘₚₜ is greater than the second threshold THₐₜₜₑₘₚₜ (2) and less than the first threshold THₐₜₜₑₘₚₜ (1), the NMS 107 checks whether there are any UEs communicating with the base station (operation 404). When a UE is found to be communicating with the base station, the NMS 107 commands the base station to forcibly hand the UE over to a nearby base station and then switch from the active mode to the DRX mode (operation 407).

When the measured level Nₐₜₜₑₘₚₜ is equal to or greater than the first threshold THₐₜₜₑₘₚₜ (1), the NMS 107 checks whether the power mode of the base station is in the DRX mode (operation 405). When the power mode of the base station is in the DRX mode, the NMS 107 commands the base station to switch from the DRX mode to the active mode (operation 408).

For convenience of implementation, the level of traffic served by a base station may be the number of outgoing calls or paging calls attempted by UEs. In addition, the second threshold THₐₜₜₑₘₚₜ (2), which is the number of call attempts per unit time, may be set to ‘zero.’ In addition, this may apply to a home cell base station (HeNB) which serves a small number of UEs. A communication system operator may select actual operating parameters for the threshold THₐₜₜₑₘₚₜ and the measured level Nₐₜₜₑₘₚₜ based on his or her system operation experience. When the first and second thresholds are set to the same value (the second threshold THₐₜₜₑₘₚₜ (2)=the first threshold THₐₜₜₑₘₚₜ (1)), operations 405 and 406 are omitted.

FIG. 5 is a flowchart illustrating a process in which a base station changes its power mode according to the measured level of traffic being served by the base station, under the control of an NMS 504. Referring to FIG. 5, an MHR node 501 is connected to the NMS 504 via a macro base station (MeNB) 502 and a packet core network (EPC) 503. The MHR node 501 represents a small base station such as a home cell base station (HeNB).

In the active mode, the MHR node 501 measures a level of traffic that it is serving and determines whether the measured level exceeds a predetermined threshold (operation 505). When the measured level exceeds the predetermined threshold, the MHR node 501 includes the measured level in a status report message and sends the status report message to the NMS 501 (operation 506). The NMS 504 receives the status report message from the MHR node 501 and compares the measured level with a predefined threshold to determine the power mode of the MHR node 501 (operation 507). The NMS 504 includes the determined power mode in a status command message and sends the status command message to the MHR node 501. The MHR node 501 receives the status command message and switches from the active mode to the DRX mode (operation 508).

The subsequent process is to reawaken the MHR node 501 in the DRX mode. There are two methods that can be used in this reawakening process. In a first method, the MeNB 502 measures the level of traffic of the MHR node 501 and sends the measured level to the NMS 504. Then, the NMS 504 determines the power mode of the MHR node 501 and thus awakens the MHR node 501. That is, the MeNB 502 monitors the status of the MHR node 501 under its jurisdiction and measures the level of newly generated traffic. When the measured level exceeds a predetermined threshold, the MeNB 502 sends a status report message containing the measured level to the NMS 504 (operations 509 and 510). Accordingly, the NMS 504 awakens the MHR node 501, that is, commands the MHR node 501 to switch from the active mode to the DRX mode.

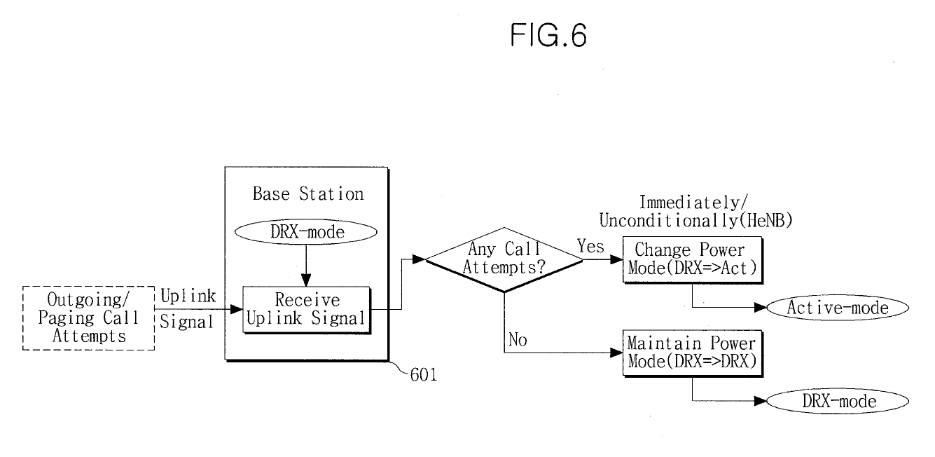

In a second method, referring to FIG. 6, a MeNB 601 itself monitors uplink signals in a physical layer L1 and switches to the active mode when one or more call attempts by UEs is detected. The level of traffic is measured in a second layer (L2: media access control (MAC), radio link protocol (RLP), or packet data convergence protocol (PDCL)) of a base station, and a call attempt is detected in the physical layer L1.

A communication service provider may select one of the above two methods in view of implementation complexity and system performance. In FIG. 5, if the base station is a home cell base station (HeNB) instead of the MHR node 501, a home gateway (HeNB GW) plays the role of the MeNB 502.

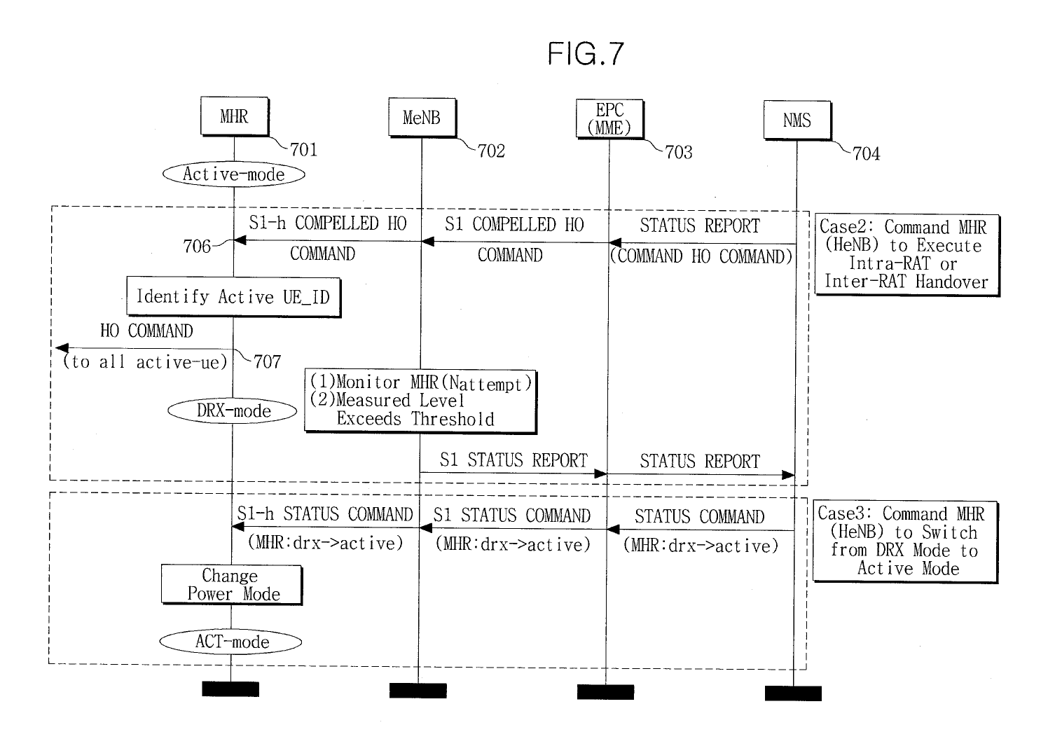

FIG. 7 is a flowchart illustrating a process in which a base station changes its power mode under the control of an NMS 704 when the level of traffic being served by the base station is between the first threshold THₐₜₜₑₘₚₜ(1) and the second threshold THₐₜₜₑₘₚₜ(2).

Referring to FIG. 7, the NMS 704 sends a status command message to an MHR node 701 to command the MHR node 701 to perform a handover operation and then switch to the DRX mode (operation 705). The status command message is delivered to the MHR node 701 via a packet core network (EPC) 703 and a macro base station (MeNB) 702 (operation 706). When receiving the status command message, the MHR node 701 identifies a UE that it is currently serving, hands the UE to a nearby base station, and then switches to the DRX mode (operation 707). The subsequent process is to reawaken the MHR node 701 in the DRX mode. This reawakening process is identical to that described above with reference to FIG. 5, and thus a detailed description thereof will be omitted.

The process of FIG. 7 is different from the process of FIG. 5 in that the MHR node 701 hands a UE that it is serving over to a nearby base station. Here, the NMS 704 may select a target base station by comprehensively considering access network status parameters such as traffic load, billing level, interference level, and received signal level. In addition, the MHR node 701 may execute one of intra-radio access technology (RAT) handover (HO) and inter-RAT HO, according to radio environment and service characteristics.

As apparent from the above description, a base station can operate in one of an active mode and a DRX mode according to the level of traffic that it is serving. Specifically, when no traffic is generated (e.g., at night), the base station changes its power mode from the active mode to the DRX mode. Thus, power consumption and carbon dioxide emission can be reduced, and interference between adjacent cells can be reduced. In particular, when the level of traffic being served by the base station is less than a predetermined level, the base station hands the traffic over to a nearby base station, thereby providing traffic concentration and improving efficiency of traffic operation. In addition, when no traffic is generated, the base station enters the DRX mode instead of being completely turned off. Thus, the base station can be normalized quickly (within about 100 ms), that is, can quickly change its power mode from the DRX mode to the active mode. The present invention is particularly effective when applied to a small base station such as a home cell base station (HeNB) or a relay node.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of operating a base station with low power consumption in a mobile communication system, the method comprising:
reporting status information about a level of traffic being served by a base station in an active mode to an apparatus for managing power consumption of the base station; and
switching from the active mode to an inactive mode in response to a mode change command from the apparatus which receives the status information report.

2. The method of claim 1, wherein the level of traffic is the number of call attempts made by user equipments (UEs) in a unit of time.

3. The method of claim 1, wherein the inactive mode is a discontinuous reception (DRX) mode.

4. The method of claim 1, wherein the base station is one of a home cell base station and a relay node.

5. The method of claim 1, further comprising handing a UE currently being served by the base station over to a nearby base station in response to the mode change command from the apparatus, wherein the switching from the active mode to the inactive mode is performed after the handing of the UE to the nearby base station.

6. The method of claim 1, further comprising switching from the inactive mode to the active mode in response to the mode change command from the apparatus.

7. The method of claim 3, further comprising determining, in the DRX mode, whether there is a call attempt made by a UE in a physical layer and switching from the DRX mode to the active mode when a call attempt does occur.

8. A method of controlling power consumption of a base station using an external apparatus, the method comprising:
receiving information about a level of traffic being served by a base station; and
controlling a power mode of the base station based on the received information.

9. The method of claim 8, wherein the controlling of the power mode comprises:
comparing the level of traffic with a predetermined threshold; and
controlling the base station to operate in an active mode when the level of traffic is equal to or greater than the predetermined threshold and controlling the base station to operate in an inactive mode when the level of traffic is less than the predetermined threshold.

10. The method of claim 9, wherein the inactive mode is a DRX mode.

11. The method of claim 8, wherein the controlling of the power mode comprises:
comparing the level of traffic with first and second thresholds; and
controlling the base station to operate in the active mode when the level of traffic is equal to or greater than the first threshold, controlling the base station to operate in the inactive mode when the level of traffic is less than the second threshold, and controlling the base station to hand a UE being served by the base station over to a nearby base station and then operate in the inactive mode when the level of traffic is equal to or greater than the second threshold and less than the first threshold.

12. The method of claim 11, wherein the inactive mode is the DRX mode.

13. The method of claim 8, wherein the external apparatus is a network management server.

14. A method of controlling power consumption of a base station using an external apparatus, the method comprising:
receiving information about a level of traffic being served by a base station from the base station in an active mode;
comparing the level of traffic with a predetermined threshold;
controlling the base station to operate in an inactive mode when the level of traffic is less is than the predetermined threshold;
monitoring the base station to detect call attempts to the base station in the inactive mode; and
controlling the base station to operate in the active mode when the number of call attempts to the base station is equal to or greater than the predetermined threshold.

15. The method of claim 14, wherein the inactive mode is a DRX mode.

16. The method of claim 14, wherein the external apparatus is one of a macro base station (Macro eNodeB) and a multi-hop relay node.

17. A method of controlling power consumption of a base station using an external apparatus, the method comprising:
receiving information about a level of traffic being served by a base station from the base station in an active mode;
comparing the level of traffic with first and second thresholds;
controlling the base station to operate in an inactive mode when the level of traffic is less than the second threshold and controlling the base station to hand a UE being served by the base station over to a nearby base station and then operate in the inactive mode when the level of traffic is equal to or greater than the second threshold and less than the first threshold;
monitoring the base station to detect call attempts to the base station in the inactive mode; and
controlling the base station to operate in the active mode when the number of call attempts to the base station is equal to or greater than the first threshold.

18. The method of claim 17, wherein the inactive mode is a DRX mode.

19. The method of claim 17, wherein the external apparatus is one of a macro base station and a multi-hop relay node.
